(19) United States
(12) Patent Application Publication
(10) Pub. No.: US 2015/0029902 A1
(43) Pub. Date: Jan. 29, 2015

(54) AIRWORTHY CAN BUS SYSTEM

(71) Applicants: Thorsten Tischler, Bremen (DE); Sven Heithecker, Bremen (DE); Carl-Heinz Hanke, Langwedel (DE); Marian Kirchner, Bremen (DE); Bjorn Kuck, Wallhofen (DE); Torsten Frerichs, Hude (DE)

(72) Inventors: Thorsten Tischler, Bremen (DE); Sven Heithecker, Bremen (DE); Carl-Heinz Hanke, Langwedel (DE); Marian Kirchner, Bremen (DE); Bjorn Kuck, Wallhofen (DE); Torsten Frerichs, Hude (DE)

(73) Assignee: Cassidian Airborne Solutions GmbH, Bremen (DE)

(21) Appl. No.: 14/344,096

(22) PCT Filed: Aug. 15, 2012
(86) PCT No.: PCT/EP2012/065928

§ 371 Date: Oct. 8, 2014

(30) Foreign Application Priority Data
Sep. 21, 2011 (DE) 10 2011 113 842.4

(51) Int. Cl. H04L 12/40; H04L 5/14

(52) U.S. Cl. CPC H04L 12/40189; H04L 5/14; H04L 2012/40215; H04L 2012/4028
USPC 370/276

(57) ABSTRACT

The invention relates to an airworthy CAN bus system having a plurality of subscribers which are networked to one another by a CAN bus having dual redundancy and are able to interchange data, wherein a bus master polls the other bus subscribers at regular intervals and supplies them with data, and the bus master and all the other bus subscribers are of two-channel design, with each channel independently delivering data and at the same time being able to concomitantly read the data from the respective other channel.

### 1. TECHNICAL FIELD IN WHICH THE INVENTION CAN BE USED

aircraft (aeroplanes, rotary-wing aircraft, unmanned vehicles (“drones”))

wherever safety-critical data are transmitted via CAN bus and where a great EMC burden can be expected.

### 2. PROBLEMS INVOLVED

To transmit safety-critical data (e.g. flight control) via a CAN bus from one or more bus users in the aircraft etc. under high electromagnetic loading (e.g. injected interference currents of at least 40 mA (unshielded or defective) cable, or 150 mA (shielded cable, lightning strike, etc.) with high security (=no wrong data) and reliability (=greatest possible availability of data). In this case, very high safety requirements are set for data which, in the case of faulty transmission, lead to the loss of the aircraft and thus also endanger human lives. Such data are usually not transmitted (exclusively) on bus systems.

### 3. SOLUTIONS TO THE PROBLEMS AND ADVANTAGES

The solution to the problem consists of a CAN bus system having up to 16 users who are networked with one another by a CAN bus having dual redundancy and can exchange data via this CAN bus. There is a bus master which polls the other bus users at regular intervals (e.g. 25 ms) (polling=real-time capable) and supplies them with data (control). The bus master and all the other bus users are of two-channel design, each channel independently delivering data and at the same time being able to concomitantly read the data from the respective other channel (higher availability and higher safety requirements). The transmitted useful data (within the CAN protocol) are protected by a 16-bit checksum (higher safety requirements and reliability). Furthermore, the CAN bus can be operated with a length of up to 100 m and a speed of up to 500 kbit/s. The electrical design of the connection of the bus users to the CAN bus allows reliable operation of the CAN bus under high electromagnetic loading (e.g. injected interference currents of at least 40 mA (unshielded (or defective) cable, or 150 mA (shielded cable and lightning strike etc.) to transmit with high security (=no wrong data) and reliability (=greatest possible availability of the data). The advantage of such a solution is the possibility of transmitting safety-critical data in an aircraft even under poor EMC conditions.

In the electronic design, the use of an additional Common Mode Choke in differential mode can be considered to be the core of the invention.

### 4. REPRESENTATION OF THE INVENTION

To transmit safety-critical data (e.g. flight control) via a CAN bus from one or more bus users in the aircraft etc. under high electromagnetic loading (e.g. injected interference currents of at least 40 mA (unshielded (or defective) cable, or 150 mA (shielded cable, lightning strike etc.) with high security (=no wrong data) and reliability (=greatest possible availability of the data). In the present case, very high safety requirements are set for data which, in the case of a faulty transmission, lead to the loss of the aircraft and thus also endanger human lives. Such data are usually not (exclusively) transmitted on bus systems.

The solution to the problem consists of a CAN bus system having up to 16 users who are networked with one another by a CAN bus having dual redundancy and can exchange data via this CAN bus. There is a bus master which polls the other bus users at regular intervals (e.g. 25 ms) (polling =real-time capable) and supplies them with data (control). The bus master and all the other bus users are of two-channel design, each channel independently delivering data and at the same time being able to concomitantly read the data from the respective other channel (higher availability and higher safety requirements). The transmitted useful data (within the CAN protocol) are protected in the data domain by a further 16-bit checksum (in addition to the 16-bit checksum generally contained in the CAN message). Furthermore, the CAN bus can be operated with a length of up to 100 m and a speed of up to 500 kbit/s.

The electrical design of the connection of the bus users to the CAN bus allows a reliable operation of the CAN bus under high electromagnetic loading (e.g. injected interference current of at least 40 mA (unshielded (or defective) cable, or 150 mA (shielded cable and lightning strike etc.) to transmit with high security (=no wrong data) and for reliability (=greatest possible availability of the data). The advantage of this solution is the possibility of transmitting safety-critical data in an aircraft also under difficult EMC conditions.

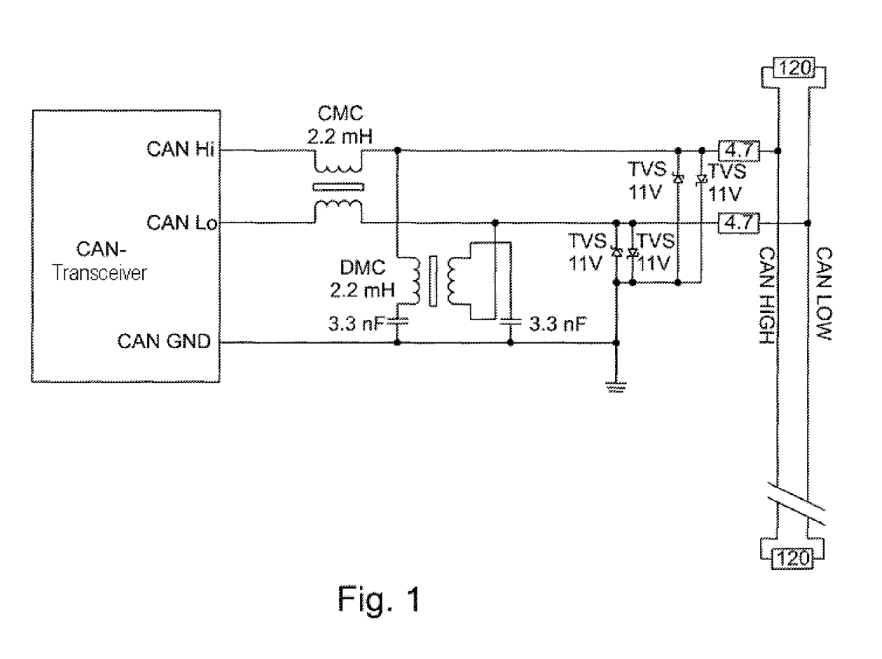

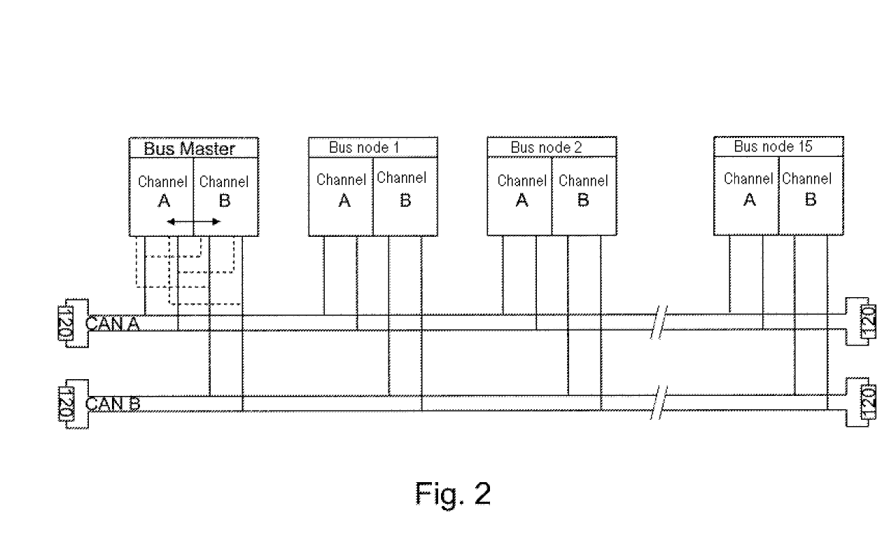

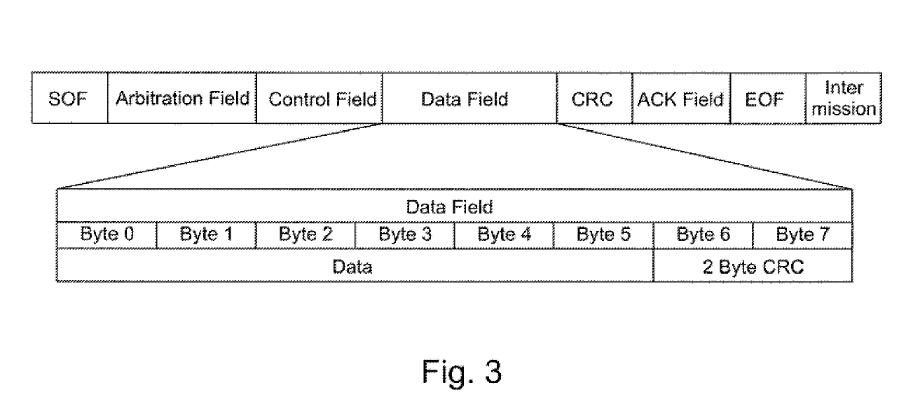

Electronic structure of an exemplary embodiment: In the electronic design, the use of an additional Common Mode Choke in differential mode (=Differential Mode Choke) can be considered to be the electronic core of the invention (see FIG. 1).

The mode of operation of this circuit is that the differential useful signals of the CAN bus pass along the desired longitudinal signal path through the Common Mode Choke (CMC). The transverse signal path through the DMC and the downstream y-capacitors is of high impedance to the differential useful signals since the DMC inductances are effective for the useful signals. This effectively prevents an additional capacitive loading of the CAN bus by the downstream capacitors.

Interfering common-mode currents impressed during EMC tests (bulk current injection—BCI test method) are attenuated by the CMC in the longitudinal signal path which corresponds to the standard filter circuit for CAN buses. In addition, a low-impedance transverse signal path is opened to these interfering common-mode currents by the DMC and the downstream capacitors. The transverse signal path is of low impedance because the interfering currents flow differentially through the choke and the inductances thus do not become effective. As a result, the low-impedance transverse path effectively prevents high interfering common-mode voltage from arising.

### Structure of the CAN Architecture:

To ensure high availability of the data, the CAN bus should be designed to have dual (or also triple) redundancy. I.e. the CAN bus architecture consists of a master and up to 15 bus users which are in each case connected to one another via 2 (or 3) separate CAN buses.

The CAN buses for channel A and channel B are separate, the bus master also being able to access the CAN channels “crossed” (dashed lines). The crossed access is used for higher availability (reconfiguration) of the CAN bus system. If the CAN buses A and B are polled synchronously, a bus master channel can also concomitantly read the data of the other bus node channels in order to be able to make a comparison of the data of channel A and channel B. This is used for higher data safety. If the CAN bus architecture is designed to have three channels, a 2-of-3 decision (2003 voter) can be made about the data of the 3 channels.

### Structure of the CAN Bus Data:

The CAN bus architecture consists of a master and up to 15 bus users. The master polls the CAN bus regularly (i.e. every 25 ms) and calls up data from all other bus users. Any changes in the status data of the bus nodes can be indicated, for example by one bit, in the data packets regularly polled and can then be requested, dedicated by the master, at the bus users concerned. In order to transmit a secure transmission of the useful data via the CAN bus, the user data are always transmitted with a 16-bit checksum.

```
#define CRC_POLY_16 0xC86C
#define CRC_SEED 0xFFFF
void CompeteRDECRC(unsigned char* buf)
{
  const unsigned short poly = CRC_POLY_16;
  unsigned short crc = CRC_SEED;
  inf count, i;
  for( i = 0; i < 6; i + + )
  {
    for( count = 0; count < 8; count++)
      crc = (((( [symbol] >> count) & 1) \hat{ } (crc & 0x01)) ? (crc >> 1) \hat{ } poly: crc>>
  }
  but[6] = (unsigned char)((crc >>8) & 0xFF);
  but[7] = (unsigned char)( crc & 0xFF);
} [symbol]
indicates data missing or illegible when filed
```

### Challenge:

A reliable solution is to be implemented for the use of aircraft for transmitting safety-critical data via CAN bus, which allows
1. high data rates (up to 500 kBit/s minimum)
2. large bus lengths (up to 100 m)
3. high noise immunity (BCI up to 60 mA unshielded cable, BCI 150 mA shielded cable)
4. high noise immunity against lightning strike
5. very reliable data transmission
6. up to 16 bus users
   and meets the respective applicable development guidelines for aircraft.

1. An airworthy CAN bus system, a CAN bus having dual redundancy and comprising and via which a number of users who are networked with one another by can exchange data, wherein a bus master polls the other bus users at regular intervals and supplies them with data, the bus master and all other bus users are of two-channel design, each channel independently delivering data and at the same time being able to concomitantly read the data from the respective other channel.

2. The system as claimed in claim 1, wherein transmitted useful data are protected by a 16-bit checksum.

3. The system as claimed in claim 1, wherein an additional Common Mode Choke is used in differential mode.
